SEQUENCE LISTING (6 sequences)

SEQ ID NO: 1 - protein, 10 aa, artificial sequence
  Synthetic Polypeptide
CPSVDGGWTC

SEQ ID NO: 2 - protein, 13 aa, artificial sequence
  Synthetic Polypeptide
CHSACSKHCFVHC

SEQ ID NO: 3 - protein, 13 aa, artificial sequence
  Synthetic Polypeptide
CHSACSKHCFVYC

SEQ ID NO: 4 - protein, 6 aa, artificial sequence
  Synthetic Polypeptide
HSSKLQ

SEQ ID NO: 5 - protein, 7 aa, artificial sequence
  Synthetic Polypeptide
KGISSQY

SEQ ID NO: 6 - protein, 7 aa, artificial sequence
  Synthetic Polypeptide
LGGSSQL

(19) United States
(12) Patent Application Publication
(10) Pub. No.: US 2009/0270266 A1
(43) Pub. Date: Oct. 29, 2009

(54) Method for Electrocatalytic Protein Detection

(76) Inventors: Shana O. Kelley, Toronto (CA); Marcel Roberts, Brighton, MA (US)

Correspondence Address: WOLF GREENFIELD & SACKS, P.C., 600 ATLANTIC AVENUE, BOSTON, MA, 02210-2206, US

(21) Appl. No.: 11/918,373

(22) PCT Filed: Apr. 12, 2006
(86) PCT No.: PCT/US06/13771

§ 371 Date: Feb. 20, 2009

Related U.S. Application Data
(60) Provisional application No. 60/670,406, filed on Apr. 12, 2005.

(51) Int. Cl. C40B 30/04; G01N 27/26; B82B 1/00; B82B 3/00

(52) U.S. Cl. 506/9; 205/777.5; 205/780.5; 977/762; 977/958

(57) ABSTRACT

The present invention provides a method of detecting an analyte in a sample with probe-modified electrodes and measuring an electrocatalytic signal generated by a binding of an analyte in the sample to a probe.

### RELATED APPLICATION

This application claims priority to U.S. Provisional Application No. 60/670,406, filed Apr. 11, 2005, entitled, “Method for Electrocatalytic Protein Detection,” and is incorporated by reference in it entirety.

### GOVERNMENT SUPPORT

The invention was supported, in whole or in part, by grant MURI from DARPA. The Government has certain rights in the invention.

### BACKGROUND

Protein detection continues to play a vital role in all areas of clinical diagnosis and medical treatment. For one, accurate protein detection is a powerful tool for the identification of disease-related biomarkers. As such, there remains a continuing need in the art for devices and methods which accurately detect minute quantities of proteins from a wide variety of samples.

The detection of an analyte using electrochemical readout is particularly attractive for the development of clinical diagnostics. Quantitative electrochemical measurements of this type can be made using compact and inexpensive instrumentation. Assignee's co-pending patent application, U.S. patent application Ser. No. 10/913,925, the entirety of which is incorporated herein by reference, discloses the use of an electrocatalytic assay for the detection of nucleic acids. There is a need in the art for a similar type of device and method which would allow for the identification of an analyte by an electrocatalytic assay. Further, there is a need in the art to utilize nanotechnology, more specifically, electrodes utilizing a single nanowire or a plurality of nanowires, in such an electrocatalytic assay.

The present invention relates to protein detection; more specifically, the present invention relates to electrocatalytic protein detection.

Provided herein, according to one aspect, are methods for electrochemical detection of an analyte, comprising contacting a probe-modified electrode with a sample and measuring an electrocatalytic signal.

In one embodiment, the electrocatalytic signal is generated by a binding of the target protein in the sample to the probe, wherein a change of the signal detected relative to a signal of a control sample comprising no target protein is indicative of the presence of the target protein in the sample.

In one embodiment, the target protein analyte is PSA.

In one embodiment, the analyte is a biomarker for a condition.

In one embodiment, the biomarker is one or more of BRCA1, BRCA1, Her2/neu, alpha-feto protein, beta-2 microglobulin, bladder tumor antigen, Cancer antigen 15-3, Cancer antigen 19-9, human chorionic gonadotropin, cancer antigen 72-4, cancer antigen 125, calcitonin, carcino-embryonic antigen), EGFR (Her-1), Estrogen receptors, Progesterone receptors, Monoclonal immunoglobulins, neuron-specific enolase, NMP22, thyroglobulin, progesterone receptors, prostate specific antigen total prostate specific antigen free, prostate-specific membrane antigen, prostatic acid phosphatase, S-100, and TA-90, or a portion, variation or fragment thereof.

In another embodiment, the electrode comprises a single nanostructure.

In one embodiment, the nanostructure is a nonowire.

In another embodiment, the electrode comprises a plurality of nanostructures.

In another embodiment, the nanowires comprise a three-dimensional configuration.

In one embodiment, the three-dimensional configuration of the nanowires assists in attracting the analyte to the electrode.

In another embodiment, the nanostructures comprise an array.

In one embodiment, the electrode comprises one or more probes.

In another embodiment, the probes are for different analytes.

Provided herein, according to one aspect, are methods of detecting a target peptide in a sample, comprising providing a probe-modified electrode comprising a plurality of nanowires wherein the nanowires are modified by a plurality of probes; contacting the probe-modified electrode with a sample; and measuring an electrocatalytic signal.

In one embodiment, the signal is generated by a binding of the analyte in the sample to the probe.

In another embodiment, a change of the signal detected relative to a signal of a control sample comprising no analyte is indicative of the presence of the analyte in the sample.

In another embodiment, the sample further comprises a redox pair having a first transition metal complex and a second transition metal complex.

In one embodiment, the first transition metal complex comprises a metal selected from the group consisting of cobalt, iron, molybdenum, osmium, ruthenium and rhenium.

In another embodiment, the second transition metal complex comprises a metal selected from the group consisting of iron, cobalt molybdenum, iridium, osmium and rhenium.

In another embodiment, the first transition metal complex is a transition metal ammonium complex.

In one embodiment, the second transition metal complex is a transition cyanate or chloride complex.

In another embodiment, the analyte is PSA.

In one embodiment, the analyte is a cancer biomarker.

Provided herein, according to one aspect, are methods of performing a multiplexed assay for analyzing a plurality of biomarkers, comprising contacting the first probe-modified electrode with a first sample; measuring a first electrocatalytic signal generated by a binding of a first analyte in the first sample to the first probe, contacting a second probe-modified electrode with a second sample; and measuring a second electrocatalytic signal generated by a binding of the second analyte in the second sample to the second probe.

In another embodiment, a change of the signal detected relative to a signal of a control sample comprising no first analyte is indicative of the presence of the first analyte in the first sample and wherein a change of the signal detected relative to a signal of a control sample comprising no second analyte is indicative of the presence of the second analyte in the second sample.

In another embodiment, the first analyte is PSA.

In one embodiment, the first probe-modified electrode and the second probe-modified electrode each comprise a plurality of nanowires wherein the nanowires comprise a three-dimensional configuration.

The present invention provides a method for electrochemical detection of an analyte, comprising providing a probe-modified electrode wherein an electrode is engaged to a probe. Next, the probe-modified electrode is contacted with a sample. Finally, the method comprises measuring an electrocatalytic signal generated by a binding of the analyte in the sample to the probe, wherein a change of the signal detected relative to a signal of a control sample comprising no analyte is indicative of the presence of the analyte in the sample.

Also the method comprises measuring an electrocatalytic signal after reaction of analyte with probe post protein binding, wherein a change of the signal detected relative to a signal of a control sample comprising a non reactive probe is indicative of the presence of the analyte and its activity in the sample.

Next, the present invention provides a method of detecting an analyte in a sample, comprising providing a probe-modified electrode having a single nanowire or a plurality of nanowires wherein a plurality of probes are engaged to the nanowires. Further, the method comprises contacting the probe-modified electrode with a sample. Finally, the method comprises measuring an electrocatalytic signal generated by a binding of the analyte in the sample to the probe, wherein a change of the signal detected relative to a signal of a control sample comprising no analyte is indicative of the presence of the analyte in the sample.

Additionally, the present invention discloses a method of performing a multiplexed assay for analyzing a plurality of biomarkers in parallel. The method comprises providing a first container having a first probe-modified electrode wherein the electrode is engaged to a first probe and contacting the first probe-modified electrode with a first sample. Next, the method discloses measuring a first electrocatalytic signal generated by a binding of a first analyte in the first sample to the first probe, wherein a change of the signal detected relative to a signal of a control sample comprising no first analyte is indicative of the presence of the first analyte in the first sample. Further, the method comprises providing a second container having a second probe-modified electrode wherein the second electrode is engaged to a second probe, contacting the second probe-modified electrode with a second sample and measuring a second electrocatalytic signal generated by a binding of the second analyte in the second sample to the second probe, wherein a change of the signal detected relative to a signal of a control sample comprising no second analyte is indicative of the presence of the second analyte in the second sample.

### BRIEF DESCRIPTION OF THE DRAWINGS

The present invention will be further explained with reference to the attached drawings, wherein like structures are referred to by like numerals throughout the several views. The drawings shown are not necessarily to scale, with emphasis instead generally being placed upon illustrating the principles of the present invention.

FIG. 1 shows an electrode of the present invention wherein the electrode comprises a plurality of nanowires.

FIG. 2A shows an electrode of the present invention wherein the electrode is engaged to a probe specific to PSA or a probe specific to a PSA-complex. FIG. 2B shows an electrode of the present invention wherein the electrode is engaged to a plurality of probes specific for PSA or a PSA-complex.

FIG. 3 shows a redox pair of the present invention.

FIG. 4A shows an electrode of the present invention having a plurality of nanowires with a two-dimensional morphology. FIG. 4B shows an electrode of the present invention having a plurality of nanowires with a three-dimensional morphology.

FIG. 5A shows scheme of displacement of the transition metal complex Ru(NH₃)₆⁺ upon binding of PSA. FIG. 5B shows data demonstrating the displacement of the transition metal complex Ru(NH₃)₆⁺ upon introduction of PSA to control modified nanowires or to probe modified nanowires.

FIG. 6A shows scheme for loss of catalytic signal due to catalytic activity of PSA. FIG. 6B shows scheme wherein an increase of catalytic signal is observed after catalytic activity of PSA.

While the above-identified drawings set forth preferred embodiments of the present invention, other embodiments of the present invention are also contemplated, as noted in the discussion. This disclosure presents illustrative embodiments of the present invention by way of representation and not limitation. Numerous other modifications and embodiments can be devised by those skilled in the art which fall within the scope and spirit of the principles of the present invention.

### DETAILED DESCRIPTION

The present invention provides a method for the electrochemical detection of a analyte. In one embodiment of the invention, a sample which may contain the analyte is placed into contact with an electrode. In one embodiment of the invention, the electrode is modified by engaging a probe to the electrode thereby creating a probe-modified electrode. In one embodiment, a peptide acts as the probe in that the peptide is capable of binding to the analyte with a desired specificity. In one embodiment, the probe is an antibody. In one embodiment, the probe is a nucleic acid aptamer.

In one embodiment, the electrode of the present invention comprises a plurality of nanowires. In one embodiment, the electrode comprises a single nanowire. In one embodiment, the various probes (e.g., peptides that bind the analyte with a desired specificity) are engaged at various positions along each nanowire. In one embodiment, the plurality of nanowires produce a three-dimensional configuration. In one embodiment, the three-dimensional configuration assists in attracting the analyte in a sample towards the electrode. As such, in one embodiment, the efficiency of the detection assay is increased through the use of the nanowires of the present invention.

### DEFINITIONS

“Solid support,” as used herein, refers to the material to which the protein probe is attached. Suitable solid supports are available commercially, and will be apparent to the skilled person. The supports can be manufactured from materials such as glass, ceramics, silica and silicon, and can incorporate conductive material to serve as an electrode. Conductive supports with a gold surface may also be used. The supports usually comprise a flat, planar surface, or at least a structure in which the probes to be engaged are in approximately the same plane. The support can be an electrode, or can be attached to an electrode.

As used herein, the term “probe” means a probe capable of binding to at least a portion of the analyte sought to be detected. The probe binds to the analyte with a desired specificity. As an example, the probe may comprise a peptide, an antibody or a nucleic acid aptamer.

As used herein, “analyte” refers to, for example, a protein, a peptide, a protein complex, and/or a biomarker, (e.g., PSA, BRCA1, BRCA1, Her2/neu, AFP (Alpha-feto protein), B2M (Beta-2 microglobulin), BTA (Bladder tumor antigen), CA 15-3 (Cancer antigen 15-3), CA 19-9 (Cancer antigen 19-9), hCG (Human chorionic gonadotropin), CA 72-4 (Cancer antigen 72-4), CA-125 (Cancer antigen 125), Calcitonin, CEA (Carcino-embryonic antigen), EGFR (Her-1), Estrogen receptors, Progesterone receptors, Monoclonal immunoglobulins, NSE (Neuron-specific enolase), NMP22, thyroglobulin, monoclonal immunoglobulins, NSE (Neuron-specific enolase), progesterone receptors PSA (Prostate specific antigen), total and free, prostate-specific membrane antigen (PSMA), prostatic acid phosphatase (PAP), S-100, and TA-90, or a portion or variation or fragment thereof.

As used herein, the term “a change of the signal” means that the signal generated from binding between a protein target and a probe is different than that generated from either of said protein target or probe alone. In one embodiment, the difference is at least about 10%, at least about 15%, about 25%, about 30%, about 40%, about 50%, about 65%, about 75%, about 85%, about 90%, about 95%, about more than 100%, about twofold, about ten fold, about fifty fold, or greater. Generally, a change of the signal indicates that the analyte is bound to the probe.

As used herein, the term “a transition metal” refers to any of the elements found between the Group IIA Elements and the Group IIB Elements in the periodic table. Transition metals to be used in a transition metal complex of the present invention include those of the fourth, fifth, and sixth periods of the periodic table of elements. In one embodiment, the transition metals used in the present invention include iron, ruthenium, cobalt, molybdenum, osmium and rhenium.

As used herein, the term “transition metal complex” refers to a structure composed of a central transition metal atom or ion, generally a cation, surrounded by a number of negatively charged or neutral ligands possessing lone pair electrons that can be given to the central metal. The transition metal is defined herein above. The ligands bind to the central transition metal using dative bonds. There are a number of different types of ligands that can be applied to the present invention. Non-limiting examples, include but are not limited to, monodentate ligands, bidendate ligands, tridendate ligands, tetradentate ligands and hexadentaate ligands, etc. Preferably, the ligands can be pyridine-based, phenathroline-based, heterocyclic, aquo, aromatic, chloride (CI⁻), or ammonia (NH₃), or cyanide (CN⁻).

As used herein, “nanostructure” refers to, for example, nanoparticles, nanodots, nanorods, nanowires, nanocones, nanocylinders. Nanostructures are sized, for example, from between about 0.0001 to about 999 nanometers in length; from between about 0.001 to about 250 nanometers; from between about 0.01 to about 200 nanometers; from between about 0.1 to about 100 nanometers; from between about 1 to about 50 nanometers; or from between about 10 to about 25 nanometers in length. Nanostructures are sized, for example, from between about 0.0001 to about 999 nanometers in diameter; from between about 0.001 to about 250 nanometers; from between about 0.01 to about 200 nanometers; from between about 0.1 to about 100 nanometers; from between about 1 to about 50 nanometers; or from between about 10 to about 25 nanometers in diameter. As used herein, the term “nanowire” refers to wires of length ranging from 0.001 to 999 nanometers and of diameters ranging from 0 to 100 nanometers. The lengths may also range from 1 to about 500, or from 50 to about 100 nanometers. The diameters may range from 1 to about 50, or from about 10 to about 25 nanometers. The composition of the wires can be of any conductive material. In one embodiment the nanowires are at least in part polycrystalline gold. In one embodiment the nanowires are composed at least in part of carbon. Those skilled in the art will recognize that various compositions are within the spirit and scope of the present invention.

As used herein, binding of the target protein in the sample to the probe includes, for example, direct and indirect binding, for example, through another binding partner or as a complex.

As used herein, “nanostructures arrays” refer to nanostructures configured in an array, for example, a low or a high density array. For example, a nanostructure array may be made of a glass microscope slide (first solid support) with, for example, 9 imprinted conductive 3×10⁻⁶ cm² circular patches. From each patch a separate line of the same material may terminate to a 1×10⁻⁵ cm² lead. The instrument may be connected using electrical clamps. An electrolessly filled track-etched filter may be annealed, which may be obtained from Osmonics, Inc. The array may be assembled as a 3D NEEs by using the modified glass slide instead of the adhesive copper tape. Once assembled each patch, having a 3D nanowires linked through the membrane to the leads, may have similar or a different probe specific for one or different analytes attached, bound or associated to it. As each lead may be addressed individually, different binding events or reactions may be monitored simultaneously. Those skilled in the art will recognize that various compositions of the solid supports are within the spirit and scope of the present invention, for example, glass, silica, metal, and the like. Those skilled in the art will recognize that various quantities of patches, leads and pads on the solid are within the scope and spirit of the invention, for example, high density and low density arrays, from for example, between about 2 and about 5000; from between about 10 and about 1000; from between about 100 and about 100; or from between about 25 and about 50. Those skilled in the art will recognize that various types of nanostructures are within the scope and spirit of the invention, for examples, those described infra. Those skilled in the art will recognize that various dimensions and shapes the patches and leads are within the scope and spirit of the invention. Those skilled in the art will recognize that various analytes and reactions are within the scope and spirit of the invention.

Electrodes may comprise one or more probes. For example, the one or more probes may be for the same analyte, but be either the same epitope or a different epitope. That is the probe may attract or bind the same or different site of an analyte. Probes may also be for different analytes and for multiple epitopes on different analytes.

### Electrocatalytic Detection of Analytes Using Peptide-Modified Electrodes

The present invention provides a method for protein detection wherein the presence of a analyte is detected by a change in an electrocatalytic signal. The use of such an electrical readout provides a method which is inexpensive, extremely sensitive, easy to miniaturize and easy to automate.

The present invention provides an electrocatalytic assay for the detection an analyte. In one embodiment, the method comprises providing a container wherein an electrode and a sample of the present invention may be placed in the container. Further, the container allows the sample to engage the electrode. Those skilled in the art will recognize that various containers are within the spirit and scope of the present invention.

In one embodiment of the present invention, an electrode is provided wherein the electrode may be modified so that the electrode is capable of binding to an analyte. In one embodiment, the electrode of the present invention is modified by engaging a peptide to the electrode wherein the peptide is known to bind to the analyte. In one embodiment, the electrode of the present invention is modified by engaging a peptide to the electrode wherein the peptide is known to bind to the analyte and has been modified to contain a redox moiety. In one embodiment, the peptide acts as a probe in that the peptide engaged to the electrode specifically binds to the analyte. In one embodiment, the peptide acts as a reactive probe in that the peptide engaged to the electrode specifically binds to the target and is reacted on, e.g., the probe can be cleaved, oxidized or reduced. In one embodiment, the peptide is functionalized with a redox moiety, e.g., ferrocene or methylene blue. In one embodiment, the probe is an antibody. In one embodiment, the probe is a nucleic acid aptamer. In one embodiment, a plurality of probes are engaged to various positions of the electrode with a desired specificity. In one embodiment, various types of probes are engaged to the electrode. In one embodiment, an electrode comprises layers of various probes. Those skilled in the art will recognize that various probes are within the spirit and scope of the present invention. In addition, those skilled in the art will recognize that the probes may be engaged at various positions on the electrode and remain within the spirit and scope of the present invention.

Furthermore, those skilled in the art will recognize all the reactions the protein can have with the probe and remain in the spirit and scope of the present invention. Also those skilled in the art will recognize that any redox active molecules used to functionalize the probes is within the spirit and scope of the present invention.

In one embodiment of the present invention, the probes are engaged to the electrode in a manner that allows for a significant portion of the probe to be available to bind to the analyte. In one embodiment, the probe is engaged to the electrode at a single position. In one embodiment, the probe is engaged to the electrode at a plurality of positions. Those skilled in the art will recognize that the probes may be engaged to the electrode in any manner and remain within the spirit and scope of the present invention.

In one embodiment, the electrode of the present invention comprises a nanowire. In one embodiment, the electrode of the present invention comprises a plurality of nanowires. Those skilled in the art will recognize that any number of nanowires is within the spirit and scope of the present invention. Furthermore, those skilled in the art will recognize that any configuration or shape of nanowire is within the spirit and scope of the present invention.

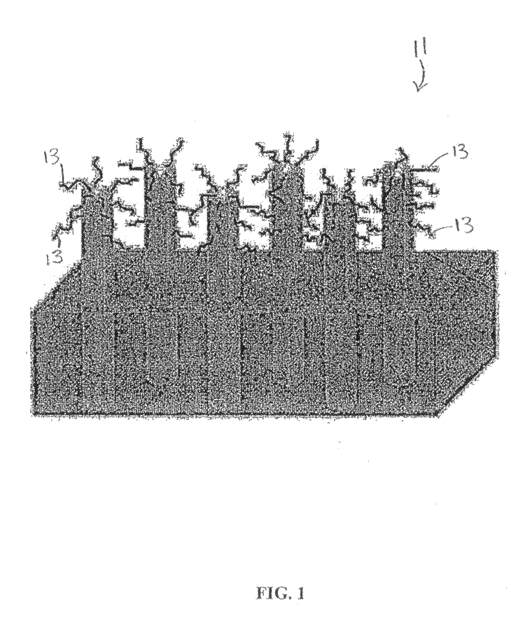

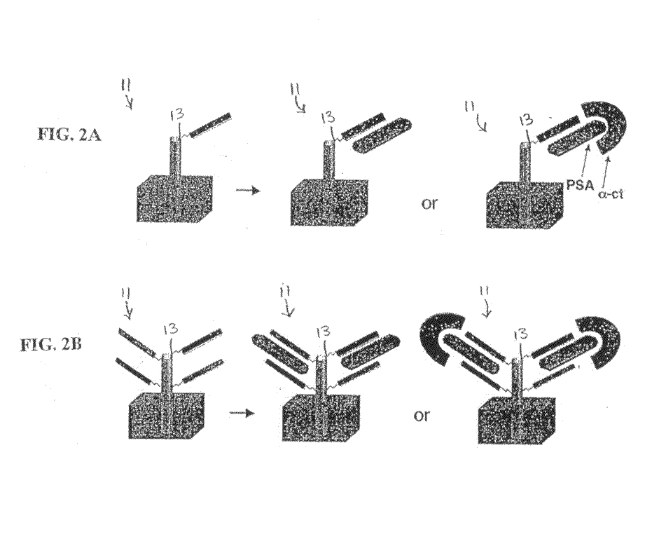

FIG. 1 shows an electrode 11 of the present invention comprising a plurality of nanowires 13. The nanowires 13 may be of any shape, number, and/or material and remain within the spirit and scope of the present invention. As shown in FIG. 1, the nanowires 13 may have a three-dimensional morphology. Those skilled in the art will recognize that various morphologies are within the spirit and scope of the present invention.

In one embodiment, a single probe is engaged to a nanowire of the present invention. In one embodiment, a plurality of probes are engaged to a plurality of nanowires of the present invention. Those skilled in the art will recognize that any number of probes may be positioned on a single or on multiple nanowires and remain within the spirit and scope of the present invention.

In one embodiment of the present invention, a plurality of nanowires of the present invention have a two-dimensional morphology. In one embodiment, a plurality of nanowires of the present invention have a three-dimensional morphology. Those skilled in the art will recognize that various morphologies are within the spirit and scope of the present invention.

In one embodiment of the present invention, a plurality of nanowires having a three-dimensional morphology assists in drawing analytes from a sample towards the electrode. In addition, a plurality of nanowires having a three-dimensional morphology creates a great deal of surface area available to interact with the analyte. As such, electrodes comprising a three-dimensional morphology increases the efficiency of the electrochemical assay. In one embodiment, complexation is more facile on a three-dimensional architecture because the surface bound probes are more accessible to the target. In one embodiment, the curvature of the tip of the nanowire provides a more penetrable film structure than a flat substrate.

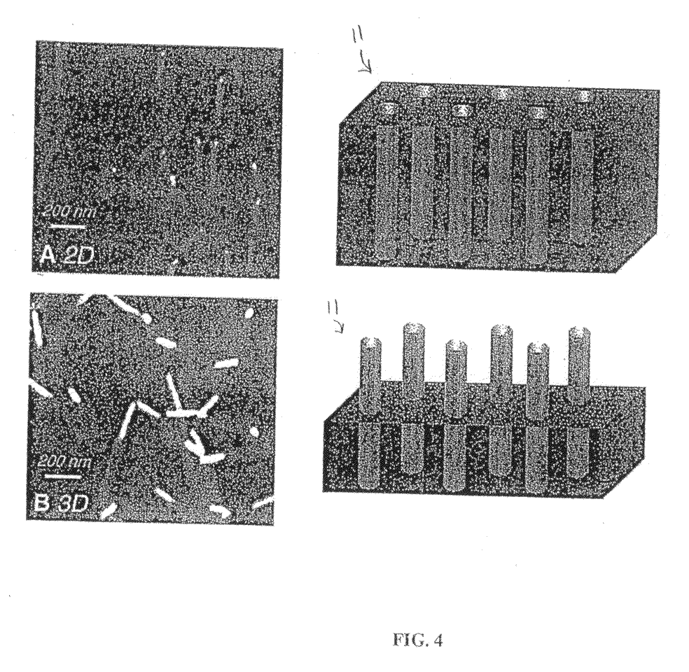

In one embodiment of the present invention, a sample comprises a redox pair. The method of the present invention exploits a reaction between a redox pair comprising a probe-binding compound and a redox-active probe. FIG. 3 shows a redox pair of the present invention.

In one embodiment, the probe-binding compound is a transition metal complex. In one embodiment, the transition metal of the transition metal complex is one selected from the group consisting of cobalt, iron, molybdenum, osmium, ruthenium and rhenium. In one embodiment, the transition metal complex is an ammonium complex of the transition metal.

In one embodiment, the transition metal complex is Ru (NH₃)₆³⁺.

In one embodiment, the redox active probe can also be a transition metal complex. In one embodiment, the transition metal of the transition metal complex is one selected from the group consisting of cobalt, molybdenum, iridium, osmium, iron and rhenium. In one embodiment, the transition metal complex is a cyanate or chloride complex of the transition metal. In one embodiment, the transition metal complex is Fe (CN)₆⁻³. In one embodiment, the second transition metal complex is iridium chloride complex, preferably with iridium in its oxidative states ranging from +3 to +6 states. In one embodiment, the iridium chloride complex is IrCl₆⁻² or IrCl₆⁻³.

In one embodiment, the redox active probe can also be an organic molecule such as ascorbic acid or tripropylamine.

In one embodiment, the probe-binding compound binds to the probe primarily through electrostatic interactions with the probe, and therefore its electrochemical reduction yields a signal that reports on the increase of negatively charged groups at the electrode surface upon binding of an analyte. The signal is amplified by the transition metal or organic oxidant of the redox active probe which permits the transition metal to be regenerated for multiple cycles.

In one embodiment, the probe-binding compound binds to the probe primarily through hydrophobic interactions with the probe, and therefore its electrochemical reduction yields a signal that reports on the increase hydrophobic groups at the electrode surface upon binding of an analyte. The signal is amplified by the transition metal or organic oxidant of the redox active probe which permits the transition metal to be regenerated for multiple cycles.

The present invention discloses a method for determining the presence of a analyte in a sample by electrochemical detection. In one embodiment, a sample suspected of containing the analyte may optionally be treated to release any protein contained within the sample. In one embodiment, the sample can be serum, blood, other bodily fluids, tissue, etc. In one embodiment, the sample can also be from a human, an animal, a plant, etc. In one embodiment, the sample can also be protein washed from a swab or some other type of material used to wipe surfaces to detect contaminants. In one embodiment, the sample can also be protein extracted or washed off of a filter through which air is passed, e.g. a filter from an air filtration system, in the case of detecting airborne bioterror agents. Such an article can be treated to extract the analyte by methods that are known in the art, e.g., forensics and contamination detection. The protein extracted from the article can be tested directly by the methods described herein, or can be amplified to enhance detection. Those skilled in the art will recognize that various samples are within the spirit and scope of the present invention.

In one embodiment, the invention features a method of detecting protein binding between a probe and an analyte in a sample, where the method includes the steps of: (a) providing a probe immobilized on a solid substrate; (b) contacting, under binding conditions, the solid support and the immobilized probe to a solution containing the sample and a redox pair, wherein the redox pair comprises a first transition metal complex and a second transition metal complex; and (c) measuring the electrocatalytic signal generated by the binding of the probe and the analyte; where a change of the signal detected in step (c) relative to that of a control sample containing no analyte, indicates that protein binding has occurred. The method can also include an additional step of testing a control, by contacting, under binding conditions, the solid support and the immobilized probe to a solution containing no sample, and a redox pair comprising a first transition metal complex and a second transition metal complex.

In one embodiment the first transition metal complex is a form of ferrocene or ferrocene derivative. In one embodiment, the transition metal of the first transition metal complex is one selected from the group consisting of cobalt, iron, molybdenum, osmium, ruthenium and rhenium. In one embodiment, the transition metal of the first transition metal complex is ruthenium. In one embodiment, the first transition metal complex is a transition metal ammonium complex. In one embodiment, the first transition metal ammonium complex comprises a transition metal selected from the group consisting of cobalt, iron, molybdenum, osmium, ruthenium and rhenium. In one embodiment, the transition metal ammonium complex is Ru (NH₃)₆³⁺.

In one embodiment, the transition metal of the second transition metal complex is one selected from the group consisting of cobalt, iron, molybdenum, iridium, osmium and rhenium. In one embodiment, the transition metal of the second transition metal complex is iron or iridium. In one embodiment, the second transition metal complex is a transition metal cyanate complex. In one embodiment, the second transition metal cyanate complex comprises a transition metal selected from the group consisting of cobalt, iron, molybdenum, iridium, osmium and rhenium. In one embodiment, the second transition metal cyanate complex is Fe(CN)₆⁻³. In one embodiment, the second transition metal complex is a transition metal chloride complex. In one embodiment, the second transition metal chloride complex comprises a transition metal selected from the group consisting of cobalt, iron, molybdenum, iridium, osmium and rhenium. In one embodiment, the second transition metal complex is an iridium chloride complex, preferably with iridium in its oxidative states ranging from +3 to +6 states. In one embodiment, the iridium chloride complex is IrCl₆⁻² or IrCl₆⁻³.

In one embodiment, the invention also features a method of detecting protein binding between a probe and a protein target, wherein the method includes the steps of: (a) providing a probe immobilized on a solid support; (b) contacting, under binding conditions, the solid support and the immobilized probe to a solution suspected of containing the analyte and a redox pair comprising a first transition metal complex and a second transition metal complex; and (c) measuring the electrocatalytic signal generated by binding of the probe and the analyte; wherein a change of the signal detected in step (c) relative to that of an unbound probe, indicates that binding has occurred. The method can also include an additional step of testing a control, by contacting, under binding conditions, the solid support and the immobilized first nucleic acid to a solution containing no sample, and a redox pair comprising a first transition metal complex and a second transition metal complex.

In one embodiment, the transition metal of the first transition metal complex is one selected from the group consisting of cobalt, iron, molybdenum, osmium, ruthenium and rhenium. In one embodiment, the transition metal of the first transition metal complex is ruthenium. In one embodiment, the first transition metal complex is a transition metal ammonium complex. In one embodiment, the first transition metal ammonium complex comprises a transition metal selected from the group consisting of cobalt, iron, molybdenum, osmium, ruthenium and rhenium. In one embodiment, the transition metal ammonium complex is Ru(NH₃)₆³⁺.

In one embodiment, the transition metal of the second transition metal complex is one selected from the group consisting of cobalt, iron, molybdenum, iridium, osmium and rhenium. In one embodiment, the transition metal of the second transition metal complex is iron or iridium. In one embodiment, the second transition metal complex is a transition metal cyanate complex. In one embodiment, the second transition metal cyanate complex comprises a transition metal selected from the group consisting of cobalt, iron, molybdenum, iridium, osmium and rhenium. In one embodiment, the second transition metal cyanate complex is Fe(CN)₆⁻³. In one embodiment, the second transition metal complex is a transition metal chloride complex. In one embodiment, the second transition metal chloride complex comprises a transition metal selected from the group consisting of cobalt, iron, molybdenum, iridium, osmium and rhenium. In one embodiment, the second transition metal complex is an iridium chloride complex, with iridium in its oxidative states ranging from +3 to +6 states. In one embodiment, the iridium chloride complex is IrCl₆⁻² or IrCl₆⁻³.

In one embodiment, the present invention comprises a method of detecting protein binding between a probe and an analyte, where the method includes the following steps: (a) providing a probe immobilized on a solid support; (b) contacting the immobilized probe to a solution containing: (i) a transition metal complex; (c) measuring the electrocatalytic signal generated; (d) contacting the immobilized probe to a solution containing: (i) a sample thought to include the analyte, and (ii) a transition metal complex; (e) measuring the electrocatalytic signal generated; wherein a change in the signal detected in step (e) over the signal generated in step (c) indicates that binding between the probe and the analyte has occurred.

In one embodiment, the transition metal of the transition metal complex is one selected from the group consisting of cobalt, iron, molybdenum, osmium, ruthenium and rhenium. In one embodiment, the transition metal of the transition metal complex is ruthenium. In one embodiment, the transition metal complex is a transition metal ammonium complex. In one embodiment, the first transition metal ammonium complex comprises a transition metal selected from the group consisting of cobalt, iron, molybdenum, osmium, ruthenium and rhenium. In one embodiment, the transition metal ammonium complex is Ru(NH₃)₆³⁺.

In one embodiment, the solutions can also include a second transition metal complex to enhance the electrocatalytic signal generated. In one embodiment, the transition metal of the second transition metal complex is one selected from the group consisting of cobalt, iron, molybdenum, iridium, osmium and rhenium. In one embodiment, the transition metal of the second transition metal complex is iron or iridium. In one embodiment, the second transition metal complex is a transition metal cyanate complex. In one embodiment, the second transition metal cyanate complex comprises a transition metal selected from the group consisting of cobalt, iron, molybdenum, iridium, osmium and rhenium. In one embodiment, the second transition metal cyanate complex is Fe(CN)₆⁻³. In one embodiment, the second transition metal complex is a transition metal chloride complex. In one embodiment, the second transition metal chloride complex comprises a transition metal selected from the group consisting of cobalt, iron, molybdenum, iridium, osmium and rhenium. In one embodiment, the second transition metal complex is an iridium chloride complex, with iridium in its oxidative states ranging from +3 to +6 states. In one embodiment, the iridium chloride complex is IrCl₆⁻² or IrCl₆⁻³.

In one embodiment, the solutions can also include an organic molecules as a redox probe to enhance the electrocatalytic signal generated. In one embodiment, the organic molecule can be ascorbic acid or tripropylamine.

In one embodiment, the method can also include rinsing steps, e.g., rinsing the electrode between contact with the different solutions.

One embodiment of the invention additionally features a method of detecting the presence of an analyte in a sample, wherein the method includes the following steps: (a) providing a probe immobilized on a solid support; (b) contacting the immobilized probe to a solution containing: (i) a transition metal complex; (c) measuring the electrocatalytic signal generated; (d) contacting the immobilized probe to a solution containing: (i) a sample thought to include the analyte, and (ii) a transition metal complex; (e) measuring the electrocatalytic signal generated; wherein a change in the signal detected in step (e) over the signal generated in step (c) indicates the analyte is present in the sample.

In one embodiment, the transition metal of the transition metal complex is one selected from the group consisting of cobalt, iron, molybdenum, osmium, ruthenium and rhenium. In one embodiment, the transition metal of the transition metal complex is ruthenium. In one embodiment, the transition metal complex is a transition metal ammonium complex. In one embodiment, the first transition metal ammonium complex comprises a transition metal selected from the group consisting of cobalt, iron, molybdenum, osmium, ruthenium and rhenium. In one embodiment, the transition metal ammonium complex is Ru (NH₃)₆⁻³.

In one embodiment, the solutions can also include a second transition metal complex to enhance the electrocatalytic signal generated. In one embodiment, the transition metal of the second transition metal complex is one selected from the group consisting of cobalt, iron, molybdenum, iridium, osmium and rhenium. In one embodiment, the transition metal of the second transition metal complex is iron or iridium. In one embodiment, the second transition metal complex is a transition metal cyanate complex. In one embodiment, the second transition metal cyanate complex comprises a transition metal selected from the group consisting of cobalt, iron, molybdenum, iridium, osmium and rhenium. In one embodiment, the second transition metal cyanate complex is Fe(CN)₆⁻³. In one embodiment, the second transition metal complex is a transition metal chloride complex. In one embodiment, the second transition metal chloride complex comprises a transition metal selected from the group consisting of cobalt, iron, molybdenum, iridium, osmium and rhenium. In one embodiment, the second transition metal complex is an iridium chloride complex, with iridium in its oxidative states ranging from +3 to +6 states. In one embodiment, the iridium chloride complex is IrCl₆⁻² or IrCl₆⁻³.

In one embodiment, the solutions can also include an organic molecules as a redox probe to enhance the electrocatalytic signal generated. In one embodiment, the organic molecule can be ascorbic acid or tripropylamine.

In one embodiment, the method can also include rinsing steps, e.g., rinsing the electrode between contact with the different solutions.

In one embodiment, the invention features a method of detecting protein binding between a probe and an analyte in a sample, where the method includes the steps of: (a) providing a functionalized probe immobilized on a solid substrate; (b) contacting, under binding conditions, the solid support and the immobilized probe to a solution containing the sample and a transition metal complex or redox organic molecule and (c) measuring the electrocatalytic signal generated by the binding of the probe and the analyte; where a change of the signal detected in step (c) relative to that of a control sample containing no analyte, indicates that protein binding has occurred. The method can also include an additional step of testing a control, by contacting, under binding conditions, the solid support and the immobilized functionalized probe to a solution containing no sample, and a transition metal complex or redox organic molecule.

In one embodiment, the transition metal functionalized to the probe is one selected from the group consisting of cobalt, iron, molybdenum, osmium, ruthenium and rhenium. In one embodiment, the transition metal functionalized to the probe is ruthenium. In one embodiment, the transition metal functionalized to the probe is a transition metal ammonium complex. In one embodiment, the transition metal functionalized to the probe ammonium complex comprises a transition metal selected from the group consisting of cobalt, iron, molybdenum, osmium, ruthenium and rhenium. In one embodiment, the transition metal functionalized to the probe ammonium complex is Ru(NH₃)₆³⁺. In on embodiment the transition metal functionalized to the probe is a form of ferrocene or ferrocene derivative.

In one embodiment, the transition metal complex is one selected from the group consisting of cobalt, iron, molybdenum, iridium, osmium and rhenium. In one embodiment, the transition metal complex is iron or iridium. In one embodiment, the metal complex is a transition metal cyanate complex. In one embodiment, the transition metal cyanate complex comprises a transition metal selected from the group consisting of cobalt, iron, molybdenum, iridium, osmium and rhenium. In one embodiment, the transition metal cyanate complex is Fe(CN)₆⁻³. In one embodiment, the transition metal complex is a transition metal chloride complex. In one embodiment, the transition metal chloride complex comprises a transition metal selected from the group consisting of cobalt, iron, molybdenum, iridium, osmium and rhenium. In one embodiment, the transition metal complex is an iridium chloride complex, preferably with iridium in its oxidative states ranging from +3 to +6 states. In one embodiment, the iridium chloride complex is IrCl₆⁻² or IrCl₆⁻³. In one embodiment, the reactive complex is a redox active organic molecule such as ascorbic acid.

In one embodiment, the invention features a method of detecting protein binding between a probe and an analyte in a sample, where the method includes the steps of: (a) providing a reactive probe immobilized on a solid substrate; (b) contacting, under binding and reacting conditions, the solid support and the immobilized probe to a solution containing the sample and a redox pair, wherein the redox pair comprises a first transition metal complex and a second transition metal complex; and (c) measuring the electrocatalytic signal generated by the binding then reaction of the probe and the analyte; where a change of the signal detected in step (c) relative to that of a control sample containing no analyte, indicates that protein binding and reaction has occurred. The method can also include an additional step of testing a control, by contacting, under binding and reacting conditions, the solid support and the immobilized probe to a solution containing no sample, and a redox pair comprising a first transition metal complex and a second transition metal complex.

In one embodiment, the transition metal of the first transition metal complex is one selected from the group consisting of cobalt, iron, molybdenum, osmium, ruthenium and rhenium. In one embodiment, the transition metal of the first transition metal complex is ruthenium. In one embodiment, the first transition metal complex is a transition metal ammonium complex. In one embodiment, the first transition metal ammonium complex comprises a transition metal selected from the group consisting of cobalt, iron, molybdenum, osmium, ruthenium and rhenium. In one embodiment, the transition metal ammonium complex is Ru(NH₃)₆³⁺.

In one embodiment, the transition metal of the second transition metal complex is one selected from the group consisting of cobalt, iron, molybdenum, iridium, osmium and rhenium. In one embodiment, the transition metal of the second transition metal complex is iron or iridium. In one embodiment, the second transition metal complex is a transition metal cyanate complex. In one embodiment, the second transition metal cyanate complex comprises a transition metal selected from the group consisting of cobalt, iron, molybdenum, iridium, osmium and rhenium. In one embodiment, the second transition metal cyanate complex is Fe(CN)₆⁻³. In one embodiment, the second transition metal complex is a transition metal chloride complex. In one embodiment, the second transition metal chloride complex comprises a transition metal selected from the group consisting of cobalt, iron, molybdenum, iridium, osmium and rhenium. In one embodiment, the second transition metal complex is an iridium chloride complex, preferably with iridium in its oxidative states ranging from +3 to +6 states. In one embodiment, the iridium chloride complex is IrCl₆⁻² or IrCl₆⁻³.

In one embodiment, the invention features a method of detecting protein binding between a probe and an analyte in a sample, where the method includes the steps of: (a) providing a probe immobilized on a solid substrate; (b) contacting, under binding conditions, the solid support and the immobilized probe to a solution containing the sample and a transition metal complex and (c) measuring the electroanalytical signal generated by the binding of the probe and the analyte; where a change of the signal detected in step (c) relative to that of a control sample containing no analyte, indicates that protein binding has occurred. The method can also include an additional step of testing a control, by contacting, under binding conditions, the solid support and the immobilized probe to a solution containing no sample, and a transition metal complex.

In one embodiment, the transition metal complex is one selected from the group consisting of cobalt, iron, molybdenum, osmium, ruthenium and rhenium. In one embodiment, the transition metal complex is ruthenium. In one embodiment, the transition metal complex is a transition metal ammonium complex. In one embodiment, the transition metal ammonium complex comprises a transition metal selected from the group consisting of cobalt; iron, molybdenum, osmium, ruthenium and rhenium. In one embodiment, the transition metal ammonium complex is Ru(NH₃)₆³⁺.

In one embodiment of the present invention, an electrocatalytic assay allows for the detection of prostate-specific antigen (PSA). As such, in one embodiment, PSA is the analyte. In one embodiment, an electrode is modified with a peptide known to bind to PSA with a desired specificity (for example CPSVDGGWTC, CHSACSKHCFVHC, CHSACSKHCFVYC as per Leinonen and workers, Clin. Chemistry, (2002) 48, 2208.) As such, in one embodiment, a peptide known to bind PSA is the probe. In one embodiment, a peptide known to bind PSA is functionalized with a redox active molecule e.g., ferrocene, ferrocene derivative, methylene blue, and a transition metal complex; is the probe. In one embodiment, a complex of PSA and α₁-antichymotrypsin are the analyte. In one embodiment, one peptide known to bind the complex is used as a probe. In one embodiment, several peptides known to bind the complex are used as a probe. In one embodiment, the electrode comprises a single nanowire. In one embodiment, the electrode comprises a plurality of nanowires wherein the plurality of nanowires form a three-dimensional morphology. In one embodiment, the three-dimensional morphology presents an increased amount of surface area to attach probes to the nanowires and an increased ability for the various probes to engage analytes in the sample. In addition, a three-dimensional morphology of nanowires draws analytes towards the electrode and therefore increases the efficiency of the method of the present invention.

In one embodiment of the present invention, an electrocatalytic assay allows for the detection of the activity of prostate-specific antigen (PSA). As such, in one embodiment, the activity of PSA is the target. In one embodiment, an electrode is modified with a peptide known to be cleaved by PSA (for example HSSKLQ, KGISSQY, LGGSSQL as per Issacs and coworkers, Cancer Research (1996) 58, 2537) and modified to attach to the solid support. As such, in one embodiment, a peptide known to be cleaved by PSA and modified to bind to a wire is the probe. In one embodiment, a complex of PSA and α₁-antichymotrypsin are the analyte. In one embodiment, one peptide known to be cleaved by the complex and modified to bind to the wire is used as a probe. In one embodiment, several peptides known to be cleaved by the complex and modified to bind to the wire are used as a probe. In one embodiment, the electrode comprises a single nanowire. In one embodiment, the electrode comprises a plurality of nanowires wherein the plurality of nanowires form a three-dimensional morphology. In one embodiment, the three-dimensional morphology presents an increased amount of surface area to attach probes to the nanowires and an increased ability for the various probes to engage analytes in the sample. In addition, a three-dimensional morphology of nanowires draws analytes towards the electrode and therefore increases the efficiency of the method of the present invention.

PSA is a 30-kD serine protease. PSA is considered to be a biomarker for prostate cancer and is the target of routine screening tests currently conducted; however, current methods available for PSA analysis are subject to false positive rates because increased production of PSA is also caused by benign prostatic hyperplasia. However, levels of a complex between PSA and α₁-antichymotrypsin are a more reliable indicator of prostate cancer, therefore diagnostic tests must distinguish the complexed and uncomplexed forms of PSA.

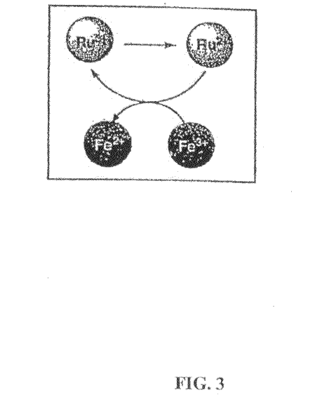

FIG. 2A shows an electrode 11 of the present invention wherein the electrode 11 comprises a nanowire 13. The nanowire is engaged to a probe wherein the probe is a peptide specific for PSA or a PSA-α₁-antichymotrypsin complex. FIG. 2B shows an embodiment wherein an electrode 11 comprises a plurality of nanowires 13 specific for PSA or a PSA-α₁-antichymotrypsin complex. A plurality of nanowires produces an electrode more capable of binding a analyte and therefore producing a more efficient assay.

In one embodiment, the present invention allows for the analysis of PSA along with other prostate cancer biomarkers in a multiplexed analysis to provide an efficient and useful diagnostic tool.

Using polysome selection, those skilled in the art have identified various peptides that may bind PSA. In one embodiment of the present invention, these peptides are engaged to an electrode wherein the peptides act as a probe for PSA, the analyte. In one embodiment, the peptide modified electrode allows the amount of PSA bound to the electrode to be quantitated through a charge in electrochemical signal.

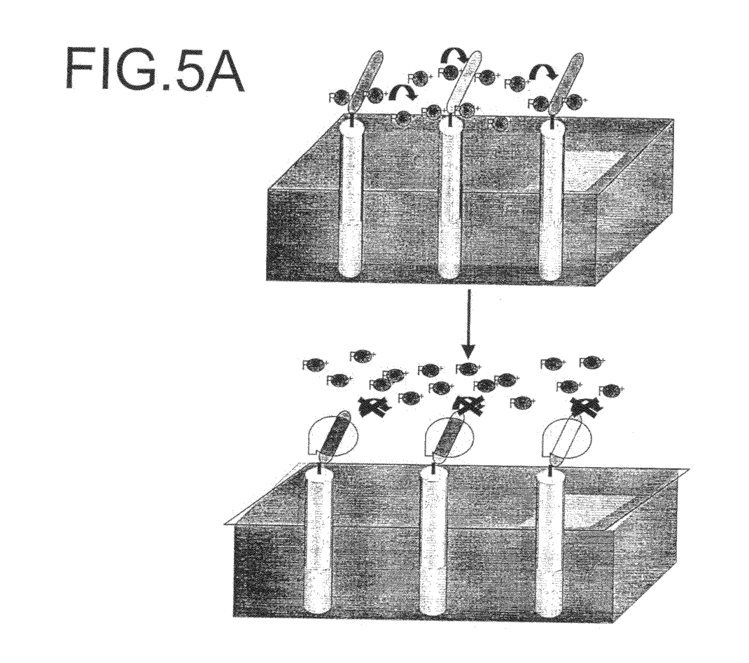

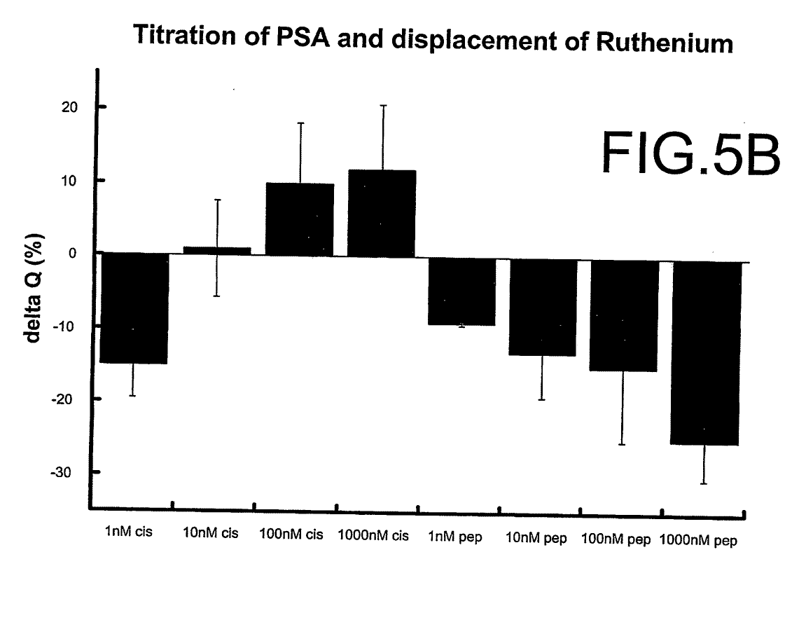

In reference to FIG. 5A, the figure depicts a scheme of displacement of the transition metal complex Ru(NH₃)₆⁺ upon binding of PSA. It is predicted that upon binding of PSA the Ru(NH₃)₆⁺ will be displaced and no longer reduced. FIG. 5B shows data demonstrating the displacement of the transition metal complex Ru(NH₃)₆⁺ upon introduction of PSA to control modified nanowires or to probe modified nanowires. A significant amount of displacement is observed when only 1 nM PSA is added to the solution. The effect of increased displacement is proportional to the increase in PSA. A plurality of nanowires produces an electrode more capable of binding an analyte and therefore producing a more efficient assay.

### Displacement of Ruthenium FIG. 5B

The NEEs fabricated as described infra. NEEs were exposed to 6 uL of either 100 mM cistamine or 500 uM probe solution in a humidity chamber at room temperature of 2 hours. The adsorption of either cistamine (non PSA binding control) or probe on the NEEs exposed surface was confirmed by scanning from 0 to 500 mV in a solution containing 2 mM ferrocyanide in 25 mM sodium phosphate (pH 7) and 25 mM sodium chloride buffer at a scan rate of 100 mVs. Attenuation of ferrocyanide signal indicates that a film has been formed on the surface.

Electrochemical measurements were conducted with a Bioanalytical Systems CV-50 potentiostat at room temperature. A three-electrode configuration was used consisting of a modified gold working electrode, a platinum wire auxiliary electrode, and an Ag/AgCl reference electrode equipped with a Luggin capillary electrode. All measurements were obtained in an aerated solution of 25 mM sodium phosphate (pH 7) and 25 mM sodium chloride buffer solution.

Currents was measured in solutions of 100 uM Ru(NH₃)₆³⁺ in 25 mM sodium phosphate/25 mM NaCl (pH 7) at a scan rate of about 100 mV/s. The cathodic charge (Q) was quantitated by integrating background-subtracted voltammograms. Signal changes corresponding to binding were calculated as follows:

ΔQ=(Q_{final}−Qᵢₙᵢₜᵢₐₗ)/Qᵢₙᵢₜᵢₐₗ

where Q_{final} and Qᵢₙᵢₜᵢₐₗ represent integrated cathodic charges after and before binding of PSA, respectively.

The initial measurement was taken after NEEs were immersed in three aliquots of 15 mL of 25 mM sodium phosphate (pH 7) and 25 mM sodium chloride buffer solution over 10 min to allow for non specifically attached cistamine or probe to diffuse away.

A titration of PSA was performed On NEEs modified with either cistamine or the probe, which were exposed to 6 uL of 1, 10, 100 and 1000 nM solutions of PSA in the same buffer solution increasingly for 30 min. After each exposition the electrode was immersed in three aliquots of 15 mL of 25 mM sodium phosphate (pH 7) and 25 mM sodium chloride buffer solution over 10 min to allow for non specifically attached PSA to diffuse away. At that point the final measurement was taken, then the NEE was exposed to the next highest concentration of PSA.

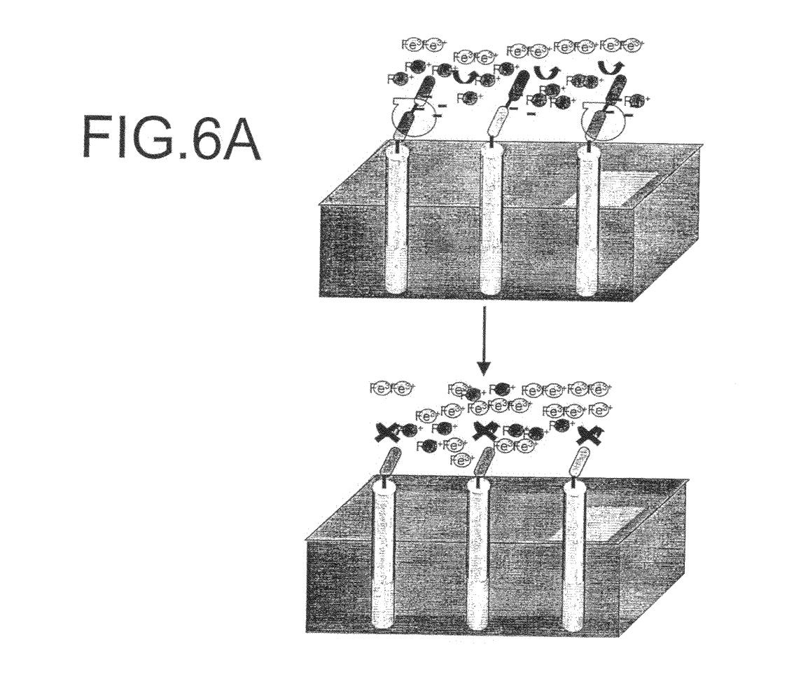

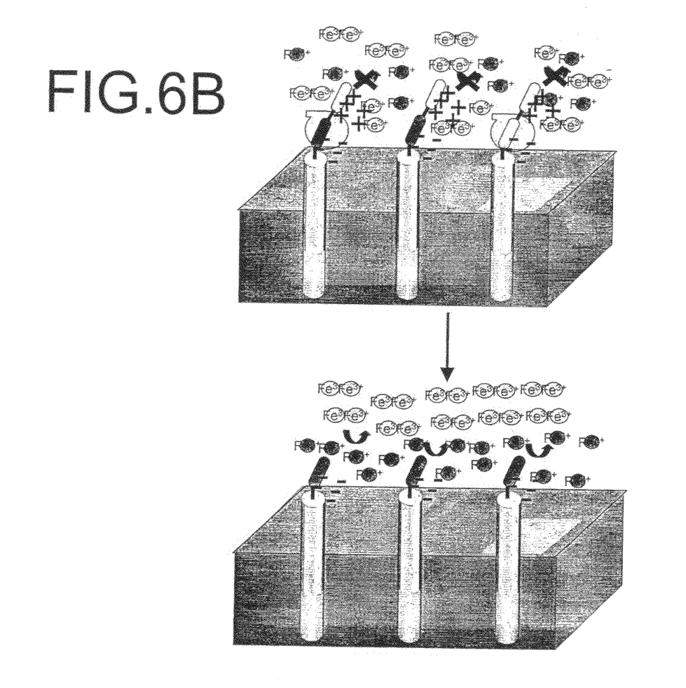

Detection Via Activity of PSA-Loss of Electrocatalysis. FIG. 6A

NEEs may be exposed to 6 uL of about 500 uM reactive probe (flanked by a negatively charged peptide sequence away from the electrode) solution in a humidity chamber at room temperature of 2 hours. The adsorption of the probe on the NEEs exposed surface w may be confirmed by scanning from 0 to 500 mV in a solution containing 2 mM ferrocyanide in 25 mM sodium phosphate (pH 7) and 25 mM sodium chloride buffer at a scan rate of 100 mVs. Attenuation of ferrocyanide signal indicates that a film has been formed on the surface.

Electrochemical measurements may be conducted with a Bioanalytical Systems CV-50 potentiostat at room temperature. A three-electrode configuration may be used consisting of a modified gold working electrode, a platinum wire auxiliary electrode, and an Ag/AgCl reference electrode equipped with a Luggin capillary electrode. All measurements will be obtained in an aerated solution of 25 mM sodium phosphate (pH 7) and 25 mM sodium chloride buffer solution.

Electrocatalytic currents may be measured in solutions of 2 mM Fe(CN)₆³⁻, 27 μM Ru(NH₃)₆³⁺ in 25 mM sodium phosphate/250 mM NaCl (pH 7) at a scan rate of about 100 mV/s. the Cathodic charge (Q) may be quantitated by integrating background-subtracted voltammograms. Signal changes corresponding to binding were calculated as follows:

ΔQ=(Q_{final}−Qᵢₙᵢₜᵢₐₗ)/Qᵢₙᵢₜᵢₐₗ

where Q_{final} and Qᵢₙᵢₜᵢₐₗ represent integrated cathodic charges after and before binding and activity, respectively. NEEs modified with the probe may be exposed to 6 uL of a 15 uM solution of PSA in the same buffer solution for 30 min. After exposition the electrode may be immersed in three aliquots of 15 mL of 25 mM sodium phosphate (pH 7) and 25 mM sodium chloride buffer solution over 10 min to allow for non specifically attached PSA to diffuse away. At that point the final measurement may be taken. The initial signal will be catalytic as the ruthenium will be attracted to the electrode and turned over by the ferricyanide. Once the negative sequence is cleaved off, the ruthenium will no longer be the first to be reduced and the catalytic signal will be lost.

The peptide ligands previously identified bind PSA with affinities (K_{d} values) in the low nM range. A practical assay for PSA requires that it can be detected at ng/mL (pM) levels. In one embodiment, the present invention allows for detection of PSA at pM levels. In one embodiment, the electrode of the present invention comprises peptide monolayers composed of several different peptide ligands. In one embodiment, pM concentrations of protein analystes are captured on solid matrices with peptides that bind at multiple sites on the protein surface. The effect apparently results from a dramatic decrease in the dissociation kinetics.

In one embodiment, a presence of PSA may be detected. In one embodiment, a presence of a PSA-α₁-antichymotrypsin complex may be detected.

In one embodiment, the sensitivity of the device is increased through the use of monolayers formed by multiple peptides engaged to the electrode. In one embodiment, a wide-variety of peptides may be used as probes. In one embodiment, a wide-variety of protein targets may be used. In one embodiment, mixed monolayers of peptides are co-deposited on an electrode to improve binding and detection.

In one embodiment, the present invention allows for the detection of PSA and its activity by using reactive probe-modified electrodes. In one embodiment detection of PSA or PSA-α₁-antichymotrypsin complex is done via the activity of PSA. In one embodiment electrodes are modified with peptides known to be cleaved by PSA or PSA-α₁-antichymotrypsin complex. In one embodiment peptides known to be cleaved by PSA or PSA-α₁-antichymotrypsin complex are generated to include amino acids with positive or negative charges under binding or reacting conditions. In one embodiment the peptide sequence known to be cleaved by PSA or PSA-α₁-antichymotrypsin complex and modified to bind to the wire is modified to be flanked by at least four negatively charged amino acids. In one embodiment the peptide sequence known to be cleaved by PSA or PSA-α₁-antichymotrypsin complex and modified to bind to the wire is modified to be flanked by at least four negatively charged amino acids on one end and flanked by an equal number of positive amino acids on the other.

In reference to FIG. 6A, a scheme for loss of catalytic signal due to catalytic activity of PSA is depicted. Upon binding of PSA then cleavage, the negatively charged peptide is released. The Ru (NH₃)₆⁺ is no longer restricted to the electrode and the electrocatalysis is lost. FIG. 6B depicts a scheme wherein an increase of catalytic signal is observed after catalytic activity of PSA. When peptide is cleaved Ru(NH₃)₆⁺ is brought towards the electrode, is Fe(CN)₆⁻³ is repelled and an increase in the catalytic signal is expected.

Detection Via Activity of PSA-Increase of Electrocatalysis. FIG. 6B

NEEs may be exposed to 6 uL of about 500 uM reactive probe (flanked by a positively charged peptide sequence on one end and a negatively charge sequence on the other that will be close to the electrode) solution in a humidity chamber at room temperature of 2 hours. The adsorption of the probe on the NEEs exposed surface w may be confirmed by scanning from 0 to 500 mV in a solution containing 2 mM ferrocyanide in 25 mM sodium phosphate (pH 7) and 25 mM sodium chloride buffer at a scan rate of 100 mVs. Attenuation of ferrocyanide signal indicates that a film has been formed on the surface.

Electrochemical measurements may be conducted with a Bioanalytical Systems CV-50 potentiostat at room temperature. A three-electrode configuration may be used consisting of a modified gold working electrode, a platinum wire auxiliary electrode, and an Ag/AgCl reference electrode equipped with a Luggin capillary electrode. All measurements will be obtained in an aerated solution of 25 mM sodium phosphate (pH 7) and 25 mM sodium chloride buffer solution.

Electrocatalytic currents may be measured in solutions of 2 mM Fe(CN)₆³⁻, 27 μM Ru(NH₃)₆³⁺ in 25 mM sodium phosphate/250 mM NaCl (pH 7) at a scan rate of about 100 mV/s. the Cathodic charge (Q) may be quantitated by integrating background-subtracted voltammograms. Signal changes corresponding to binding were calculated as follows:

ΔQ=(Q_{final}−Qᵢₙᵢₜᵢₐₗ)/Qᵢₙᵢₜᵢₐₗ

where Q_{final} and Qᵢₙᵢₜᵢₐₗ represent integrated cathodic charges after and before binding and activity, respectively. NEEs modified with the probe may be exposed to 6 uL of a 15 uM solution of PSA in the same buffer solution for 30 min. After exposition the electrode may be immersed in three aliquots of 15 mL of 25 mM sodium phosphate (pH 7) and 25 mM sodium chloride buffer solution over 10 min to allow for non specifically attached PSA to diffuse away. At that point the final measurement may be taken. The initial signal will not be catalytic as the ruthenium will kept away from to the electrode and not turned over by the ferricyanide. Once the positive sequence is cleaved off, the ruthenium will be segregated to the electrode by the negatively charged amino acids and an increase in catalysis may be observed.

In one embodiment, protein detection using probe-modified electrodes with a PSA model system allows for a multiplexed assay enabling cancer biomarker panels to be analyzed in parallel. A series of protein factors other than PSA have been identified and observed at elevated levels in prostate cancer patients. In one embodiment, E-cadherin is the analyte. In one embodiment, pim-1 kinase is the analyte. In one embodiment, hepsin is the analyte. In embodiment, AMACR is the analyte. In one embodiment, EZH2 is the analyte. In one embodiment, a plurality of these analytes are detected in parallel in order to run a multiplexed assay. Those skilled in the art will recognize that various analytes are within the spirit and scope of the present invention.

In one embodiment of the current invention, the electrocatalytic assay disclosed herein may be used as a proteomic tool assisting in cancer diagnosis and research. In one embodiment of the current invention, the electrocatalytic assay may be used to collect a proteomic “fingerprint” from biological samples using arrays of immobilized peptides.

### Detecting Proteins Using Nanoelectrode Ensembles (NEEs)

In one embodiment of the present invention, an electocatalytic assay is performed using a device comprising peptide-functionalized metallic nanoelectrode ensembles for detecting extremely low levels of protein. The application of the electrocatalytic assays on the nanoelectrode ensembles substantially expands the repertoire of protein detection scope to ultrasensitive biomolecular detection because the nanoelectrode ensembles provide very high sensitivity for biomolecular sensing.

In one embodiment, the device for ultrasensitive detection of a protein target includes an array of metallic nanoelectrode ensembles (NEEs) comprising a metallic nanowire embedded within a non-conductive substrate such as a polycarbonate membrane and a nucleic acid probe attached to the metallic nanowire. In one embodiment, the metallic nanowire comprises gold. In one embodiment, the metallic nanowire ranges from about 10 to about 80 nanometers in diameter, and the nanowires have a density on the non-conductive substrate of from about 1×10⁸ to about 1×10⁹ per square centimeters. Those skilled in the art will recognize that nanowires of various types of materials are within the spirit and scope of the present invention. Further, those skilled in the art will recognize having various densities on the non-conductive substrate are within the spirit and scope of the present invention.

In one embodiment, the array of the nanoelectrode ensembles of the present invention is two-dimensional, e.g., the nanowires on the nanoelectrodes do not protrude out of the non-conductive substrate. In another embodiment, the array of the nanoelectrode ensembles is three-dimensional, e.g., the nanowires on the nanoelectrodes protrude out of the non-conductive substrate. In one embodiment of the present invention, the nanowires that protrude out of the non-conductive substrate is about 50 to about 300 nanometers, more preferably about 100 to about 200 nanometers. Those skilled in the art will recognize that nanowires may protrude out of the non-conductive substance a wide range of distances and remain within the spirit and scope of the present invention.

Conventional techniques are used to prepare an array of the metallic nanowires and the nanoelectrode ensembles. See Menon, V P and Martin, C R, “Fabrication and Evaluation of Nanoelectrode Ensembles,” Anal. Chem., 67: 1920-1928 (1995), and Yu, S et al., “Nano Wheat Fields Prepared by Plasma-Etching Gold Nanowire-Containing Membranes,” Nano Lett., 3:815-818 (2004), which are hereby incorporated by reference. Generally, the non-conductive substrate containing nano-sized cylindrical pores is used as a template for the preparation of the nanoelectrode ensembles. The metallic nanowires are deposited into the pores on the substrate. The procedure results in the metallic nanowires within the pores of the non-conductive substrate as well as thin metallic films that cover both faces of the substrate. In one embodiment, the metallic films on both of the surfaces can be removed by applying and then removing a strip of scotch tape. The metallic films on both faces are removed to yield the two-dimensional nanoelectrode ensembles. To prepare three-dimensional nanoelectrode ensembles, the surface of the two-dimensional nanoelectrode ensembles is removed to expose the nanowires. The length of the exposed nanowire is dependent on the etching time. For example, the longer etching times result in longer nanowire exposure. Those skilled in the art will recognize that various methods of producing the nanowires are within the spirit and scope of the present invention.

In one embodiment, a probe is engaged to the nanoelectrode ensembles. In one embodiment, a probe is engaged to an exposed metallic nanowire on the non-conductive substrate.

In one embodiment, the probe is attached to the metallic nanowire via a linker that imparts the shortest connectivity and provides the highest level of conjugation so that measured electrical conductivities correspond closely to the probe, and not to the properties of the linkers. In one embodiment, films made from thiolated peptides may be generated. In one embodiment, a polymer matrix can be deposited and the probes may then be covalently attached. In one embodiment, the peptide is engaged to the nanowire in a manner allowing for the greatest amount of surface area of the peptide to engage the analyte. Those skilled in the art will recognize that various methods known in the art can be used for attaching the peptide probe to the metallic nanowires.

In one embodiment, one or a plurality of probes can be attached to a single metallic nanowire. The plurality of probes on a single nanowire or on multiple nanowires will help recognize an enhanced signal conducted to the detection device, thus, improve the sensitivity of the probe and reduce the background noise of the detection method.

In one embodiment, analyte detection may be performed with a system comprised of nanoelectrode ensembles containing the probes attached thereto as a work electrode and a reference electrode, wherein both electrodes are connected to a signal detection device. Upon contacting a sample containing an analyte with the nanoelectrode ensembles, the binding of the probe with the analyte from the sample occurs and results in changes in electrocatalytic currents. The changes associated with the binding are reflected on the amplified signal on the detecting device and thus is indicative of the presence of an analyte in the sample.

In one embodiment, the detection method includes contacting the array of nanoelectrode ensembles with a sample under a binding condition (e.g. a low ionic strength buffer at room temperature) and detecting a change in the amplified signal on the circuit that is associated with the binding of the probe on the nanoelectrode to the analyte in the sample. The change in the signal indicates the presence of the analyte in the sample. In one embodiment, the electrochemical detection method can be used to quantitatively detect the amount of the analyte in the sample. In one embodiment, the change in the amplified signal after the binding relative to the signal before the binding can be compared to a standard for obtaining the amount of the analyte in the sample. In one embodiment, the changed signal after binding can be compared to the signal associated with the binding of the probe to a control sample containing no analyte. The amount of the analyte in the sample can be deduced from the difference in the amplified signal between the two.

In one embodiment, the sample is placed in contact with the array of nanoelectrode ensembles. The contact can take place in any suitable container. Generally, the incubation of the sample in contact with the array is at temperatures normally used for binding of the analyte in the sample to the probe.

In one embodiment, the analyte to be detected can be isolated from samples like a bodily fluid from an animal, including a human, such as, but not limited to, blood, urine, lymphatic fluid, feces, tears, sweat, mucus, synovial fluid, bile, phlegm, saliva, menstrual fluid and semen. In one embodiment, samples containing analytes can, for example, be found in fluids from a plant, such as, but not limited to, xylem fluid, phloem fluid and plant exudates. In one embodiment, samples containing analytes may, for example also be found in non-living sources such as, but not limited to, food, sewage, forensic samples, lakes, reservoirs, rivers and oceans. In one embodiment, analytes can also be those of defunct or extinct organisms, e.g., pressed plants in herbarium collections, or from pelts, taxidermy displays, fossils, or those of biological materials in museum collections. Those skilled in the art will recognize that analytes may be obtained from a wide variety of sources and be within the spirit and scope of the present invention.

In one embodiment, once the sample has been treated to expose any analyte, the solution can be tested as described herein to detect binding between the attached probe and the analyte, if such is present. Alternatively, some samples can be tested directly, e.g., the target may exist in a serum sample and can be directly accessible, and may not require treatment to release the protein.

The detection method of the present invention using nanoelectrode ensembles offers numerous advantages over those other detection methods. Such advantages include very high sensitivity, good control, good reproducibility, label free and simple operation and instrumentation.

### Electrochemical Measurements

In one embodiment, electrochemical measurements may be conducted with a Bioanalytical Systems CV-50 potentiostat. In one embodiment, a one-compartment cell fitted with a Luggin capillary may be used. In one embodiment, all cyclic voltammetry measurements may be conducted at room temperature with a Bioanalytical Systems CV-50W potentiostat. In one embodiment, a three-electrode configuration may be used consisting of a modified gold working electrode, a platinum wire auxiliary electrode, and an Ag/AgCl reference electrode. In one embodiment, a one-compartment cell fitted with a Luggin capillary was used to separate the working compartment from the reference compartment.

In one embodiment, electrocatalytic currents may be measured in solutions of 2 mM Fe(CN)6³⁻, 27 μM Ru(NH₃)₆³⁺ in 25 mM sodium phosphate/250 mM NaCl (pH 7) at a scan rate of about 100 mV/s. In one embodiment, cathodic charge (Q) may be quantitated by integrating background-subtracted voltammograms. In one embodiment, signal changes corresponding to binding were calculated as follows:

ΔQ=(Q_{final}−Qᵢₙᵢₜᵢₐₗ)/Qᵢₙᵢₜᵢₐₗ

where Q_{final} and Qᵢₙᵢₜᵢₐₗ represent integrated cathodic charges after and before binding, respectively.

In one embodiment, cyclic voltammetry measurements may be performed using a Bioanalytical Systems (BAS) Epsilon potentiostat/galvanostat controlled with BAS Epsilon EC software. In one embodiment, all measurements may be conducted with a three-electrode configuration at room temperature. In one embodiment, an Ag/AgCl electrode equipped with a Luggin capillary may be used as the reference electrode, and a platinum wire may be used as the counter electrode. In one embodiment, BAS gold macroelectrodes (area=0.02 cm²), 2D and 3D NEEs were used as working electrodes. In one embodiment, all potentials may be reported versus Ag/AgCl. In one embodiment, electrocatalytic currents may be measured in solutions of about 5 mM Fe(CN)₆³⁻ and about 100 mM Ru(NH)₆³⁺ in about 25 mM sodium phosphate/250 mM NaCl (pH=7) at a scan rate of about 100 mV/s. Cathodic charge (Q) may be quantitated by integrating the area under each voltammogram, and signal changes corresponding to binding events may be calculated as follows:

DQ %={((Qfinal−Qinitial)/Qinitial)*100}

where Qfinal and Qinitial represent integrated cathodic charges after and before binding, respectively.

### Detection of Analyte Based on the Electrocatalytic Reduction of Ru(NH₃)₆³⁺ at DNA-Modified Surfaces

In one embodiment, Ru (NH₃)₆³⁺ associates electrostatically with the peptide probe. It is therefore a sequence-neutral binder and an ideal probe for quantitating analyte adsorbed on an electrode surface. In one embodiment, monitoring hybridization with Ru (NH₃)₆³⁺ allows for the electrochemical detection of an analyte DNA.

In one embodiment, in order to amplify the signals obtained at peptide-modified electrodes in the presence of Ru(NH₃)6³⁺, an oxidant, Fe(CN)₆³⁻ may be added, that permits turnover of Ru(NH₃)₆³⁺ by regenerating the oxidized form. In one embodiment, large, irreversible reductive waves may be observed at peptide-modified electrodes immersed in solutions of Fe(CN)₆³⁻ and Ru(NH₃)6³⁺, consistent with the proposed reaction cycle. In one embodiment, the electrochemical signals obtained with peptide-modified electrodes from solutions of Ru(III) and Fe(III) are amplified by about 100-fold over those obtained when only Ru(NH₃)₆³⁺ is present (no signal is obtained in this region when only Fe(CN)₆³⁻ is present). Electrocatalysis requires a peptide to attract the cation to the gold surface, as no signal is observed with a bare electrode.

### Electroless Gold Deposition

Track-etch polycarbonate filters obtained from Osmonics, Inc. were used as membrane templates. These membranes are 6 mm thick with a nominal pore diameter of about 10 nm and a pore density of about 5.2×10⁸ pores cm⁻². The NEEs were prepared using the electroless plating procedure reported previously with slight modifications. The template membrane was immersed into methanol for about 2 hours and then immersed for about 45 minutes in a solution that is 0.026 M in SnCl₂ and 0.07 M in trifluoroacetic acid in 50:50 methanol/water as the solvent. This results in deposition of the “sensitizer” (Sn²⁺) onto all membrane surfaces (both the pore walls and the membrane faces). The membrane was rinsed twice in methanol for about 2.5 minutes and immersed into a solution of AgNO₃ (0.029 M) in aqueous ammonia for 10 minutes. This results in the deposition of nanoparticles of Ag on all membrane surfaces. Membranes were then rinsed in methanol for about 5 minutes. After treatment in AgNO₃, the membrane was placed in a gold-plating mixture containing about 0.5 mL of the commercial gold-plating solution Oromerse Part B (Technic Inc., 0.127 M in Na₂SO₃, 0.625 M in formaldehyde, and 0.025 M in NaHCO₃). The temperature of this bath was maintained at about 4° C. The pH is initially about 12, but was adjusted to about 10 by dropwise addition of 0.5 M H₂SO₄, with constant stirring. Membranes were placed in the gold-plating bath for about 24 hours resulting in the deposition of Au nanowires into the pores. After plating, the membrane was rinsed with water and then immersed in 10% HNO₃ for about 12 hours. The membrane was then thoroughly rinsed in water and air-dried.

### Assembly of 2D NEEs

The 2D NEEs obtained via the electroless gold deposition method described above were assembled as reported previously with slight modifications. A small piece of the gold plated membrane was first affixed to a piece of adhesive copper tape with the “shiny” side of the gold surface facing up and the rough face of the membrane facing the adhesive. Another strip of adhesive copper was then affixed to the upper shiny gold surface and covered only a small part of the membrane. This improved the yield of making reproducible NEEs as well as electrical connection between the copper and the NEEs. The Au upper surface layer that was not covered by the Cu foil tape was then removed by whipping the surface with a cotton tipped applicators wetted with ethanol. This step exposes the disc shaped ends of Au nanowires. The NEE assembly was then heated at about 155° C. for about 30 minutes. Membranes were then insulated with 3M Scotch brand No. 898 tape on the lower and upper surfaces of the assembly as well as Cu foil tape. Prior to placement on the assembly, an about 0.07 cm² hole was punched in the upper piece of Scotch tape. This aperture defines the geometric area of the 2D NEEs exposed to solution.

### Preparation and Assembly of 3D NEEs

After the electroless deposition of gold within the polycarbonate membrane pores as well as both faces of the membrane, the 3D NEEs were prepared by O₂ plasma etching the 2D NEEs as described. The shiny side of the gold surface was removed by applying and removing a strip of 3M Scotch tape which exposed the ends of the gold nanowires. The shiny membrane surface was O₂ plasma etched using a Plasma Therma 290 Series System VII for 65 seconds. This process etches away the polycarbonate material and exposes about 200 nm of the gold nanowire ends. The etching conditions were as follows: power=100 W, oxygen pressure=150 mTorr, flow rate=30 cm³ min⁻¹. The 3D NEEs were assembled as the 2D NEEs described above and heat treated in the oven at about 155° C. for about 30 minutes to improve sealing of the polycarbonate membrane around NEEs. This fabrication process increased significantly the yield of functional 3D NEEs to about 85%. The geometric area of the 3D NEEs exposed to solution was about 0.07 cm².

FIG. 4A shows scanning electron micrographs of the structures generated using a modified version of an electroless plating method previously described. These two dimensional (2D) nanoelectrodes 11 are about 10 nm in diameter and have an average separation of about 200 nm. Using oxygen plasma etching to remove a thin layer of polycarbonate, FIG. 4B shows the same materials are used to prepare three-dimensional (3D) NEEs 11 featuring exposed Au nanowires. Plasma etching resulted in consistent exposure of about 200 nm of the gold nanowires. Sealing of the polycarbonate membrane around the NEEs 11 was achieved by heat treatment, and was a crucial step that significantly reduced the double-layer charging currents.

All patents, patent applications, and published references cited herein are hereby incorporated herein by reference in their entirety. While this invention has been particularly shown and described with references to preferred embodiments thereof, it will be understood by those skilled in the art that various changes in form and details may be made therein without departing from the scope of the invention encompassed by the appended claims.

What is claimed is:

1. A method for electrochemical detection of an analyte, comprising:
contacting a probe-modified electrode with a sample and
measuring an electrocatalytic signal.

2. The method of claim 1, wherein the electrocatalytic signal is generated by a binding of the target protein in the sample to the probe, wherein a change of the signal detected relative to a signal of a control sample comprising no target protein is indicative of the presence of the target protein in the sample.

3. The method of claim 1, wherein the target protein analyte is PSA.

4. The method of claim 1, wherein the analyte is a biomarker for a condition.

5. The method of claim 1, wherein the biomarker is one or more of BRCA1, BRCA1, Her2/neu, alpha-feto protein, beta-2 microglobulin, bladder tumor antigen, cancer antigen 15-3, cancer antigen 19-9, human chorionic gonadotropin, cancer antigen 72-4, cancer antigen 125, calcitonin, carcino-embryonic antigen, EGFR, Estrogen receptors, Progesterone receptors, Monoclonal immunoglobulins, neuron-specific enolase, NMP22, thyroglobulin, progesterone receptors, prostate specific antigen total prostate specific antigen free, prostate-specific membrane antigen, prostatic acid phosphatase, S-100, and TA-90, or a portion, variation or fragment thereof.

6. The method of claim 1, wherein the electrode comprises a single nanostructure.

7. The method of claim 6, wherein the nanostructure is a nonowire.

8. The method of claim 1, wherein the electrode comprises a plurality of nanostructures.

9. The method of claim 8, wherein the nanostructures comprise a three-dimensional configuration.

10. The method of claim 9, wherein the three-dimensional configuration of the nanowires assists in attracting the analyte to the electrode.

11. The method of claim 8, wherein the plurality of nanostructures comprise an array.

12. The method of claim 1, wherein the electrode comprises one or more probes.

13. The method of claim 12, wherein the probes are for different analytes.

14. A method of detecting a target peptide in a sample, comprising:
providing a probe-modified electrode comprising a plurality of nanowires wherein the nanowires are modified by a plurality of probes;
contacting the probe-modified electrode with a sample; and
measuring an electrocatalytic signal.

15. The method of claim 14, wherein the signal is generated by a binding of the analyte in the sample to the probe.

16. The method of claim 14, wherein a change of the signal detected relative to a signal of a control sample comprising no analyte is indicative of the presence of the analyte in the sample.

17. The method of claim 14, wherein the sample further comprises a redox pair having a first transition metal complex and a second transition metal complex.

18. The method of claim 17, wherein the first transition metal complex comprises a metal selected from the group consisting of cobalt, iron, molybdenum, osmium, ruthenium and rhenium.

19. The method of claim 18, wherein the second transition metal complex comprises a metal selected from the group consisting of iron, cobalt molybdenum, iridium, osmium and rhenium.

20. The method of claim 17, wherein the first transition metal complex is a transition metal ammonium complex.

21. The method of claim 17, wherein the second transition metal complex is a transition cyanate or chloride complex.

22. The method of claim 14, wherein the peptide is PSA.

23. The method of claim 14, wherein the peptide is a cancer biomarker.

24. A method of performing a multiplexed assay for analyzing a plurality of biomarkers, comprising:
contacting the first probe-modified electrode with a first sample;
measuring a first electrocatalytic signal generated by a binding of a first analyte in the first sample to the first probe,
contacting a second probe-modified electrode with a second sample; and
measuring a second electrocatalytic signal generated by a binding of the second analyte in the second sample to the second probe.

25. The method of claim 24, wherein a change of the signal detected relative to a signal of a control sample comprising no first analyte is indicative of the presence of the first analyte in the first sample and wherein a change of the signal detected relative to a signal of a control sample comprising no second analyte is indicative of the presence of the second analyte in the second sample.

26. The method of claim 24, wherein the first analyte is PSA.

27. The method of claim 24, wherein the first probe-modified electrode and the second probe-modified electrode each comprise a plurality of nanowires wherein the nanowires comprise a three-dimensional configuration.
